(19) United States
(12) Patent Application Publication
(10) Pub. No.: US 2020/0158145 A1
(43) Pub. Date: May 21, 2020

(54) Connection Tube for Hydraulic Cylinder

(71) Applicant: Keith Manufacturing Co., Madras, OR (US)

(72) Inventor: Edward Worth, Madras, OR (US)

(73) Assignee: Keith Manufacturing Co., Madras, OR (US)

(21) Appl. No.: 16/502,894

(22) Filed: Jul. 3, 2019

Related U.S. Application Data
(60) Provisional application No. 62/694,783, filed on Jul. 6, 2018.

(51) Int. Cl. F15B 15/14; F16L 43/02

(52) U.S. Cl. CPC F15B 15/149; F16L 15/00; F16L 43/02

(57) ABSTRACT

A hydraulic connection tube interconnects two port fittings of a hydraulic cylinder. The tube includes a bend or bent portion that reduces forces and stresses at the fittings.

### TECHNICAL FIELD

This disclosure relates to hydraulic drive cylinders that are used to move floor slats back and forth in a reciprocating floor slat conveyor system (or “moving floor” system).

### BACKGROUND

Moving floor systems are a well-known alternative to tilt-beds in trucks and trailers, although they have other kinds of applications or implementations. Generally speaking, a moving floor system consists of side-by-side floor slats across the width of a trailer. All of the floor slats move in one direction, at the same time, thereby translating the load sitting on top of the slats a certain distance. Then, a set of one-third of the slats are retracted to their original position, sliding back underneath the load. The lesser amount of friction that results from less supporting surface area being in contact with the load, as the lesser number of slats are retracted, causes the load to stay in place. This is followed by retracting another one-third of the slats, followed by retracting the final one-third, until all of the slats have returned to their initial position. This sequence is repeated until the trailer is unloaded.

The reciprocating motion of the floor slats is usually driven by hydraulic cylinders, one hydraulic cylinder for each set of one-third of the floor slats. The hydraulic cylinders are arranged as a set that is incorporated into a moving floor drive unit that includes the means for mechanically connecting the cylinders to the floor slats, the details of which are not described here, because they are well known.

Different kinds of hydraulic cylinder implementations have been designed over the years from the time moving floor systems were introduced into the marketplace. Some of these involve single-piston cylinders with rods extending from one end, the rods moving back and forth, with floor slat connections being made to the rods. This design places the cylinders on one-side of the drive unit or, in other words, off-sets the cylinders relative to the places of mechanical connection between cylinder rods and floor slats.

Other kinds of hydraulic cylinder implementations involve cylinder housings that have cylinder rods extending from opposite ends. In this implementation, the rods are fixed and the housing moves back and forth on the rods. In this case, the cylinder housing is mechanically connected to the floor slats. The hydraulic cylinder has dual drive chambers, each one essentially having a fixed wall inside that separates each drive chamber. Hydraulic fluid is pumped into different chambers, at different times, to move the cylinder housing back-and-forth on the rods at each end, as needed, in order to reciprocate the floor slats in the system.

This last kind of implementation centralizes the cylinders and the mechanical connections to the floor slats in the overall moving floor drive unit. However, one aspect of this particular design is that the cylinder housing carries external hydraulic connection tubes for moving hydraulic fluid between the various chambers inside the cylinder housing, as needed, to move the cylinder housing in one direction or the other. It is not necessary to understand the hydraulic workings of this kind of cylinder, other than the drive forces created during the course of operation of the cylinder creates different kinds of stresses on cylinder components.

In the past, the external hydraulic connection tubes described above have been made from a single, straight tube that extends a certain distance between elbows that provide hydraulic fluid connection ports to the chambers within the cylinder housing. It has been discovered that, in time, the elbow connections create points of repair.

A manufacturer of hydraulic drive units for moving floor systems wants to sell products that need to be repaired less, rather than more, because that is what the manufacturer's customers want.

The design disclosed here offers an improvement to the external hydraulic connection tube just described.

### SUMMARY

The design disclosed here is intended to be used in connection with a hydraulic cylinder housing that has at least two fluid flow connection ports that are interconnected by a flow tube. Opposite ends of the flow tube are connected to fittings that are threaded into ports in the hydraulic cylinder. These fittings are subjected to stress due to hydraulic forces from actuation of the hydraulic cylinder. Stress at the fittings is alleviated by putting one or more bends in the body of the connection tube.

### BRIEF DESCRIPTION OF THE DRAWINGS

The following is a brief description of the drawings that accompany this disclosure:

FIG. 1 is a pictorial view of hydraulic connection tubes, designed in accordance with the present disclosure, with the hydraulic tubes being connected to the outside of a cylinder housing;

FIG. 2 is a pictorial view similar to FIG. 1, but with the connection tubes exploded from the cylinder housing;

FIG. 3 is a side view of the configuration illustrated in FIG. 1;

FIG. 4 is a top view of the configuration illustrated in FIG. 1;

FIG. 5 is a side view similar to FIG. 3, but with the connection tubes exploded from the cylinder housing;

FIG. 6 is a pictorial view of one embodiment of a hydraulic connection tube, designed in accordance with the present disclosure;

FIG. 7 is a pictorial view of the hydraulic connection tube embodiment shown in FIG. 6, but with the elbow connections removed;

FIG. 8 is a pictorial view of the embodiment shown in FIG. 6, but with all fittings removed from the connection tube;

FIG. 9 is a pictorial view of the embodiment shown in FIG. 4, but with the elbow connections removed; and

FIG. 10 is a pictorial view of yet another embodiment of the hydraulic connection tube.

### DETAILED DESCRIPTION

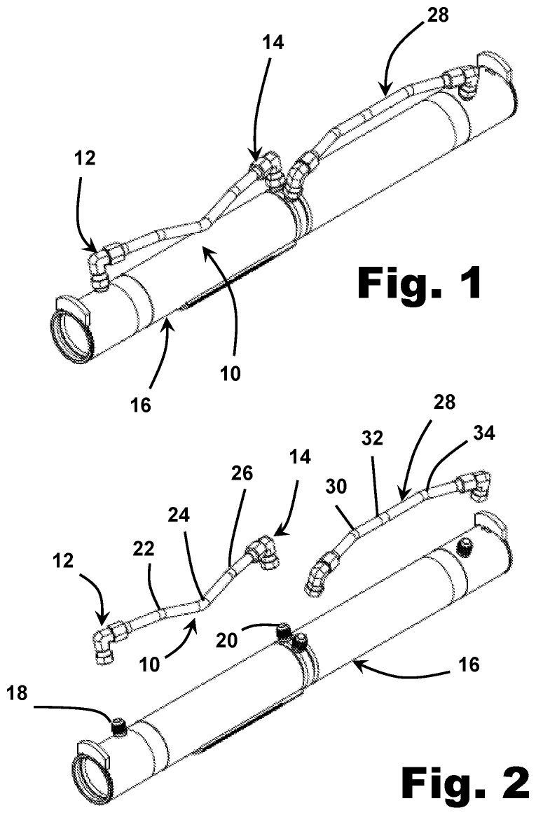

Referring now to the drawings, and first to FIG. 1, shown generally at 10 is a hydraulic connection tube constructed in accordance with the present disclosure.

The tube 10 has elbow fittings 12, 14, one at each end of the tube. These fittings 12, 14 are threaded or otherwise connected to the outside of a hydraulic cylinder housing 16 and provide fluid flow ports for hydraulic fluid to enter or leave chambers (not illustrated) inside the housing. Directing attention to FIG. 2, which shows the connection tube 10 exploded from the housing 16, the housing 16 has threaded nipple ports 18, 20 for making the elbow connections just described.

As shown in the various Figures, the connection tube 10 has one or more bends 22, 24, 26. These bends reduce force loads at the points of connection defined by nipples 18, 20 because they allow bending forces to be absorbed by the tube. In other words, in the straight tube configuration of prior art designs, the stiffness of the straight tube configuration apparently caused a degree of force concentration at the nipple location. Placing bends in the tube, as shown at 22, 24, 26, allows more flex along the length of the tube, and may reduce force concentration at the nipple location. Initial testing indicates that the bent tube design may require less maintenance and/or provide longer product life than the prior, straight tube design.

At this stage, it is not known if one type of bent tube configuration will work better than others. Reference numeral 28 points to a different tube configuration that has the same number of bends 30, 32, 34, but with a different bend pattern. Likewise, FIGS. 9 and 10 show different kinds of bend patterns at 36, 38, respectively.

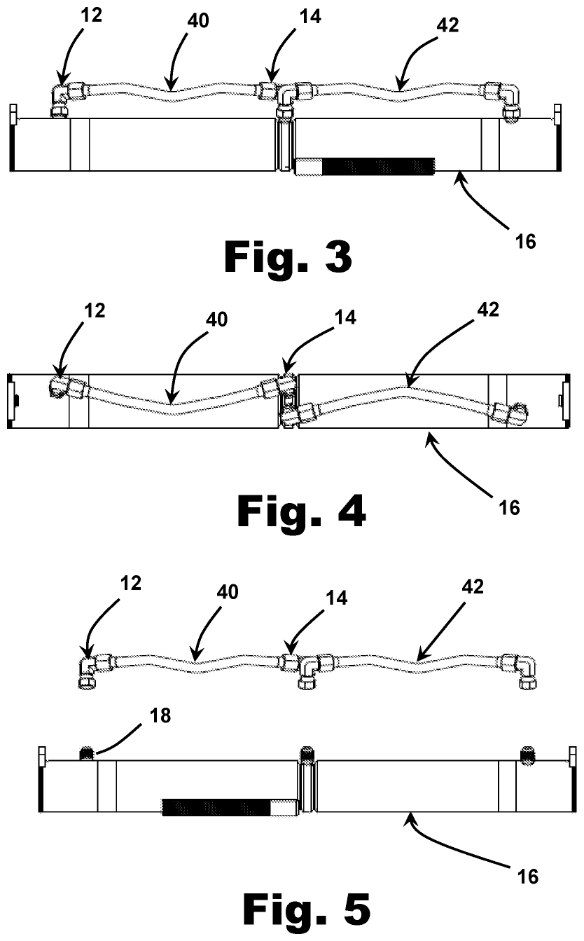

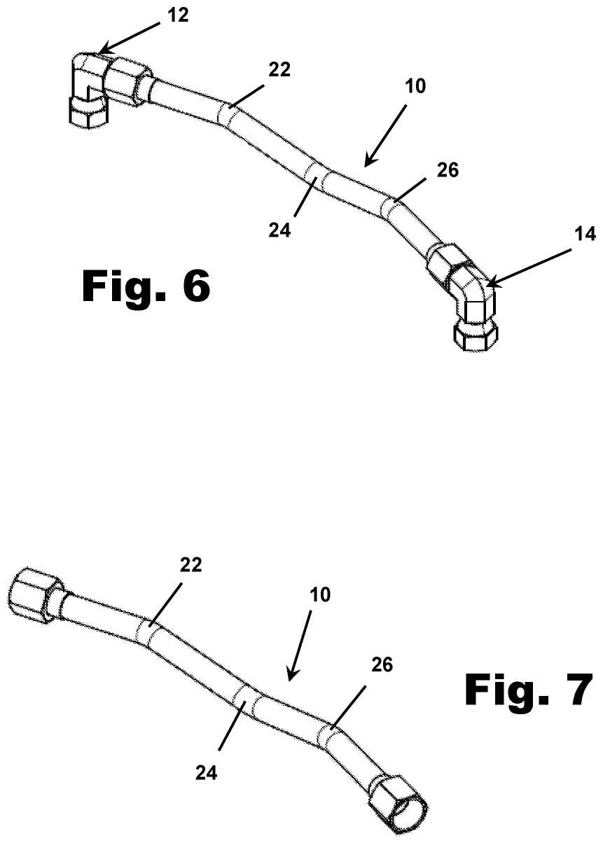

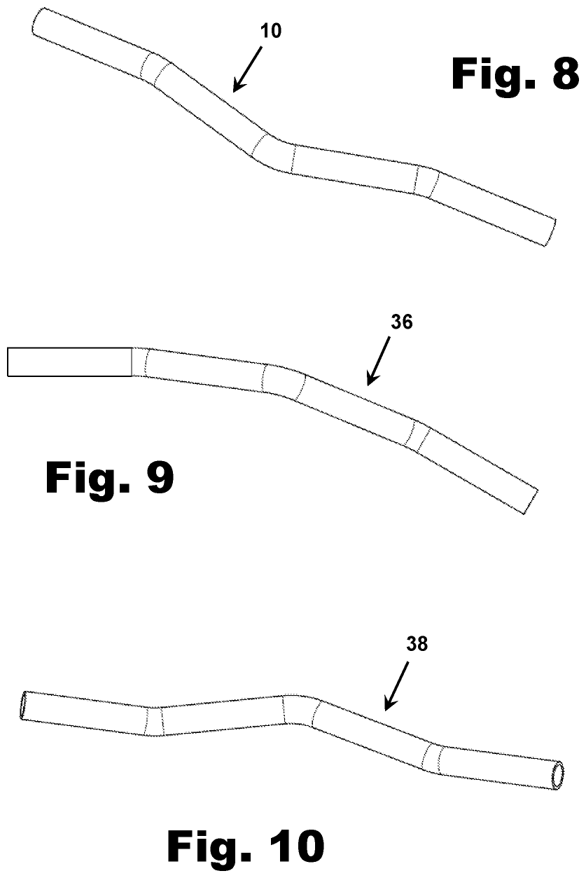

It is conceivable that the “bent tube” design disclosed here can be made from discrete sections of tube, joined together, as illustrated in FIGS. 1-2 and FIGS. 6-10. Alternatively, it may be possible to put bends in a single section of tube as shown at 40, 42 in FIGS. 3-5.

The foregoing discloses a design that is under development. The scope of patent protection is not intended to be limited by the foregoing description. Instead, patent protection is to be limited by the patent claim or claims that follow, the interpretation of which is to be made in accordance with the doctrines of patent claim interpretation.

What is claimed is:

1. For use in connection with a hydraulic cylinder housing having at least two fluid flow connection ports, an improved hydraulic connection tube for communicating a hydraulic fluid between said at least two fluid flow connection ports, comprising:
first means for connecting an end of said connection tube to one of said two fluid flow connection ports for enabling a fluid to flow through said one fluid flow connection port and into or out of said connection tube;
second means for connecting another end of said connection tube to another one of said two fluid flow connection ports for enabling a fluid to flow through said another one of said fluid flow connection ports and into or out of said connection tube; and with
said connection tube having a body portion with at least one bend for reducing force loads at points of connection defined by said first and second means.

2. The hydraulic connection tube of claim 1, wherein said first means comprises an elbow fitting threaded to a hydraulic cylinder port.

3. The hydraulic connection tube of claim 1, wherein said second means comprises an elbow fitting threaded to a hydraulic cylinder port.

4. The hydraulic connection tube of claim 1, including a plurality of bends in said body portion of said connection tube.

5. The hydraulic connection tube of claim 1, wherein said bend in said body portion of said connection tube comprises a discrete body section interconnecting a tube section on each side of said discrete body section.
